(19) United States
(12) Patent Application Publication
(10) Pub. No.: US 2017/0061515 A1
(43) Pub. Date: Mar. 2, 2017

(54) SYSTEMS AND METHODS FOR SETTING ALLOCATIONS AND PRICES FOR CONTENT IN AN ONLINE MARKETPLACE

(71) Applicant: Google Inc., Mountain View, CA (US)

(72) Inventor: Patrick Hummel, Cupertino, CA (US)

(21) Appl. No.: 14/834,016

(22) Filed: Aug. 24, 2015

(51) Int. Cl. G06Q 30/06; G06F 17/30

(52) U.S. Cl. CPC G06Q 30/0625; G06F 17/30867; G06F 17/30554; G06Q 30/0641

(57) ABSTRACT

Systems and methods of the present disclosure are directed to dynamically allocating content in an interface. Search results including first and second applications are identified responsive to a search query input into an interface of an online electronic application marketplace. A first value generated by displaying the first electronic application in a first slot available on the interface is determined. The first value is based on historical monetization generated from the first electronic application. A first candidate content item is identified for display with the search results. A second value generated by displaying the first candidate content item in the first slot is determined. Based on a comparison of the first value and the second value, the first electronic application is selected for display via the first slot of the interface and the candidate content item is selected for display via a second slot of the interface.

### BACKGROUND

In a networked environment such as the Internet, entities such as people or companies provide information for display on web pages or other interface by a computing device. The web pages can include text, video, or audio information provided by the entities via a web page server for display on the Internet. Additional content such as electronic advertisements can also be provided by third parties for display on the web pages together with the information provided by the entities. Thus, a person viewing a web page can access the information that is the subject of the web page, as well as selected third party advertisements that may or may not be related to the subject matter of the web page.

### SUMMARY

At least one aspect is directed to a method of dynamically allocating content in an online electronic marketplace graphical interface. The method can include the data processing system identifying search results responsive to a search query input into an interface of an online electronic application marketplace. The search results can include an ordered list identifying a first electronic application and a second electronic application that satisfy the search query. The data processing system can identify a first slot of a plurality of slots available on the interface to display the first search result, and a second slot of the plurality of slots to display the second search result. The data processing system can translate a display of the search results via the plurality of slots of the interface. To translate the display of the search results, the data processing system can determine a first value generated by displaying the first electronic application in the first slot available on the interface. The first value based on monitoring an historical monetization generated from selection of the first electronic application. The data processing system can identify a first candidate content item for display with the search results. The data processing system can determine a second value generated by displaying the first candidate content item in the first slot. The first value can be different from the second value. The data processing system can select, based on a comparison of the first value and the second value, the first electronic application for display via the first slot of the interface. The data processing system can determine a third value generated by displaying the second electronic application in the second slot available. The third value can be based on monitoring an historical monetization generated from selection of the second electronic application. The data processing system can determine a fourth value generated by displaying the first candidate content item in the second slot. The third value can be different from the fourth value. The data processing system can select, based on a comparison of the third value and the fourth value, the first candidate content item for display via the second slot of the interface. The data processing system can relocate, based on the comparison of the third value and the fourth value, the second electronic application to a third slot of the plurality of slots available on the interface.

At least one aspect is directed to a method of selecting content for display in an online electronic marketplace. The method can include a data processing system identifying search results responsive to a search query input into an interface of an online electronic application marketplace. The search results identify a first electronic application satisfying the search query. The data processing system can include one or more processors. The method can include the data processing system determining a first value generated by displaying the first electronic application in a first slot available on the interface for displaying the search results. The first value can be based on an historical monetization generated from selection of the first electronic application. The data processing system can identifying a first candidate content item for display with the search results. The data processing system can determine a second value generated by displaying the first candidate content item in the first slot. The first value can be different from the second value. The data processing system can select, based on a comparison of the first value and the second value, the first electronic application for display via the first slot of the interface and the first candidate content item for display via a second slot of the interface.

Another aspect is directed to a system to dynamically allocate content in an online electronic marketplace graphical interface. The system can include a data processing system comprising one or more processors. The system can include a search engine, a content selector and an allocation engine executed by the one or more processors. The search engine can identify search results responsive to a search query input into an interface of an online electronic application marketplace. The search results can include an ordered list identifying a first allocation engine can identify a first slot of a plurality of slots available on the interface to display the first search result, and a second slot of the plurality of slots to display the second search result. The content selector can identify a first candidate content item for display with the search results. The allocation engine can determine a first value generated by displaying the first electronic application in the first slot available on the interface, the first value based on monitoring an historical monetization generated from selection of the first electronic application. The allocation engine can determine a second value generated by displaying the first candidate content item in the first slot, the first value different from the second value. The allocation engine can select, based on a comparison of the first value and the second value, the first electronic application for display via the first slot of the interface. The allocation engine can determine a third value generated by displaying the second electronic application in the second slot available, the third value based on monitoring an historical monetization generated from selection of the second electronic application. The allocation engine can determine a fourth value generated by displaying the first candidate content item in the second slot, the third value different from the fourth value. The allocation engine can select, based on a comparison of the third value and the fourth value, the first candidate content item for display via the second slot of the interface. The allocation engine can relocate, based on the comparison of the third value and the fourth value, the second electronic application to a third slot of the plurality of slots available on the interface to thereby translate a display of the search results via the plurality of slots of the interface.

Another aspect is directed to a system for selection of content for display in an online electronic marketplace. The system can include a data processing system comprising one or more processors. The system can include a search engine, an allocation engine and a content selector. The search engine can identify search results responsive to a search query input into an interface of an online electronic application marketplace. The search results identify a first electronic application satisfying the search query. The allocation engine can determine a first value generated by displaying the first electronic application in a first slot available on the interface for displaying the search results. The first value can be based on an historical monetization generated from selection of the first electronic application. The content selection engine can identify a first candidate content item for display with the search results. The allocation engine can determine a second value generated by displaying the first candidate content item in the first slot. The first value can be different from the second value. The content selection engine can select based on a comparison of the first value and the second value, the first electronic application for display via the first slot of the interface and the candidate content item for display via a second slot of the interface.

Yet another aspect is directed to a non-transitory computer readable medium having instructions to select content for display on an online marketplace on a computer network. The instructions include instructions to identify search results responsive to a search query input into an interface of an online electronic application marketplace. The search results identifying a first electronic application satisfying the search query. The instructions include instructions to determine a first value generated by displaying the first electronic application in a first slot available on the interface for displaying the search results. The first value can be based on an historical monetization generated from selection of the first electronic application. The instructions include instructions to identify a first candidate content item for display with the search results. The instructions include instructions to determine a second value generated by displaying the first candidate content item in the first slot. The first value can be different from the second value. The instructions include instructions to select based on a comparison of the first value and the second value, the first electronic application for display via the first slot of the interface and the candidate content item for display via a second slot of the interface.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an illustration of a system for selection of content via a computer network in accordance with an implementation.

FIG. 2 is an illustration of a method for selecting content via a computer network in accordance with an implementation.

FIG. 3 is a schematic diagram of a system for selecting content via a computer network in accordance with an implementations.

FIG. 4 is a block diagram illustrating a general architecture for a computer system that may be employed to implement various elements of the system shown in FIGS. 1 and 3 and the method shown in FIG. 2, among others, in accordance with an implementation.

Like reference numbers and designations in the various drawings indicate like elements.

### DETAILED DESCRIPTION

The present disclosure relates to selecting content items (e.g., an online document, text, images, multimedia content, or online advertisement) for display in an online marketplace, such as an online application store. For example, the present disclosure can dynamically allocate content in an online electronic marketplace graphical interface. A data processing system may select content for display with organic search results (e.g., links to electronic applications that are responsive to a search query input by a client device or user via an interface of the online marketplace). When selecting the content item for display, the data processing system (e.g., content server, contextual serving system, advertisement server) receives bids from numerous content providers (e.g., advertisers) and enters them into an online auction (e.g., an online advertisement bidding auction). The data processing system may select a content item and organic search results for display via an interface of the online marketplace that includes a fixed number of display slots. For example, each slot may display an organic search result (such as information about an electronic application responsive to the search query) or an electronic advertisement. However, it may be challenging to determine the allocation of the candidate content items in the display slots, and/or the price to charge the content provider for the impression, selection or conversion associated with the selected content item.

The present solution is generally directed to determining an allocation or price of an electronic content item (e.g., electronic online advertisement) to be displayed alongside organic, non-advertisement search result links. The present solution determines the allocation or price by accounting for situations in which showing the advertisement adversely affects an entity's (e.g., the administrator of the online marketplace or data processing system) ability to monetize content shown via the organic, non-advertisement links. The advertisement may adversely affect the entity's ability to monetize the content shown via the organic links because the advertisement may reduce the probability that a user will select the organic link by, e.g., reducing the number of organic links that can be displayed on a search results page. Thus, the present solution can translate a display of the search results in content slots.

For example, an online electronic application marketplace or online store may include a search engine feature. The online marketplace may receive a categorical search query from a user for applications based on a category (e.g., business, communication, education, entertainment, health & fitness, photography, productivity, or games). The online marketplace may provide search results that include organic links to electronic applications that satisfy the categorical search query. Based on the user interface configuration, the online marketplace may determine that five organic links can be displayed in response to the user's categorical search results. In some cases, the online marketplace may further determine to display an advertisement with the organic links for electronic applications. To display the advertisement with the search results, the online marketplace may translate the display of search results by replacing one of the non-advertisement organic links for an electronic application with the advertisement, and relocating the electronic application to another available slot.

In some implementations, the present solution determines the optimal allocation and price for an advertisement to be shown with non-advertisement organic links for electronic applications that are responsive to a categorical search query by: (1) determining a value for all the electronic applications (e.g., based on historical logs, purchase price of application, in-app purchases, or other monetization associated with the application); (2) determining a probability of the organic link being selected based on historical ranking of the organic link in search results; (3) identifying a plurality of candidate advertisements for display and determining a top ranking advertisement based on a value of showing the advertisement (e.g., bid in auction, quality score, how much a selection is worth to the online marketplace, long term value score, likelihood of a selection); (4) iteratively comparing a value of the advertisement with a value of each organic link; (5) selecting, based on the comparison, one of the organic link or the advertisement; and (6) determining a price to charge for showing the advertisement.

In some implementations, the present solution facilitates monetizing a search results page for the online marketplace through advertising. In contrast to a search query on web search engine, when a user clicks on an organic link (a link that is not for an advertisement) in an online electronic application marketplace, an entity that runs, oversees, owns, or otherwise administers the online marketplace is likely to obtain a monetary benefit from a user selecting such a link. When a user clicks on such a link, the user may download an application on their mobile device or other computing device, and such users may generate revenue for a developer of the application either through directly purchasing the application, in-application purchases, advertising in the application, etc. Since the entity that administers the online marketplace obtains a revenue share from revenue the developer of the application earns from such a user, this in turn results in the administrator of the online marketplace obtaining a monetary benefit when a user clicks on a link that is not for an advertisement in the online marketplace.

However, if the online marketplace shows an electronic advertisement in the marketplace search results, in some cases this may reduce the probability that a user will select an organic, non-advertisement link in the search results that is not for an advertisement. For example, when a user enters a categorical search query in the online marketplace, there might be room to show five different links (e.g., five display slots) for different applications in the online marketplace within the same screen or other graphical user interface. If one of these spaces or interface display slots is taken up by an advertisement, that in turn may reduce the available room to four different non-advertisement links, which in turn may means it is less likely that a user will click on such a link because there are now only four organic links on the screen for the user to click on rather than five.

Since the administrator of the online marketplace obtains monetary value when a user selects a non-advertisement link, the present solution takes into account the reduction in the probability that a user will select such a link in deciding which allocation of advertisements to show in the online marketplace search results.

Thus, the present solution can address a problem of how to decide on the allocation of advertisements to show in the online marketplace search results by accounting for not only what advertisements are best, but also how those advertisements affect the revenue the administrator of the online marketplace might obtain from a user selecting an organic, non-advertisement link.

In various implementations, the present solution can be applied to other situations in which the presence of advertisements affect how well one can monetize a user through other non-advertising methods.

Thus, in some implementations, the present solution can address a problem of a data processing system choosing an allocation of advertisements when the allocation of advertisements selected by the data processing system in real-time (e.g., responsive to a search query or at the time of displaying search results responsive to a search query) may affect the probability that a user will click on an organic non-advertisement link and there is a direct monetary benefit to having a user click on such a non-advertisement link.

In some implementations, the present solution facilitates selecting the allocation of advertisements that will be displayed as well as the prices for these advertisements. For example, the data processing system can determine a measure of how much value could be generated by organic non-advertisement links if an advertisement is not displayed in a given slot as well as a measure of how much value could be generated by these organic links if an advertisement is displayed in a given slot, and then use these measures of the amount of value that could be generated by the organic links to influence the allocation or prices of advertisements that are selected.

In some implementations, the data processing system determines the amount of value that could be generated by the organic links under various configurations of advertisements. To do this, the data processing system determines, for each organic link of the search results, an amount of value that would be generated if a user clicked on the organic link based on historical estimates of how much revenue typically results from a user clicking on the organic link corresponding to that link. The data processing system can, for example, monitor transactions occurring with respect to the organic link to determine the historical estimate. The data processing system then determines, for each organic link, the probability that the link would be clicked if the link is shown in each of the various possible display slots on the page. For example, the data processing system can determine the probability that the link would be clicked if the link is shown in the top slot (e.g., the first slot towards the top of the visible portion of the interface of the online marketplace) as well as a number of position normalizers that reflect the decreased likelihood the organic link will be clicked if the organic link is shown in a lower position or slot. These estimates can be based on historical estimates of the probability organic links may be clicked in various positions.

The data processing system can then use these estimates of the amount of value that would be generated if a user clicked on the organic link and the probability that the link would be clicked if the link is shown in each of various possible positions on the page to determine the amount of value that would be generated by the non-organic links under various configurations of the advertisements. For example, if an advertisement is shown in the top position, and there is available room to show four organic links on the interface or screen, then the value generated by the organic links may be based on the sum of the values of these four organic links. By contrast, if no advertisement is shown, and as a result there is room to show five organic links on the screen, then the value generated by the organic links may be based on the sum of the values of these five organic links.

Upon determining an estimate of how much value could be generated by the organic links in various configurations, the data processing system can determine an allocation of advertisements to show in the search results. In some implementations, the data processing system can rank the advertisements by the value of showing the advertisement. This value estimate may be calculated using one or more of the bid of the advertiser, an estimated quality score for the advertiser such as a predicted click-through rate, a long-term value estimate for the advertiser that reflects the long-term impact that showing this ad will have on the user's propensity to click on ads in the future, or an estimate of how much revenue will result from a user clicking on the link for the ad (independent of the direct revenue from the ad auction), or a combination thereof.

The data processing system may then determine, for each advertiser in this rank, a highest position in which the advertiser can be shown where both of the following conditions are met: (a) a total value of both the non-advertising links and the advertisement that results is greater than the total value of the non-advertising links that would result if no advertisement were shown at all and (b) the total value of both the non-advertising links and the advertisement that results is greater than the total value of the non-advertising links and the advertisement that would result if this ad were shown in a lower position.

In some cases, the data processing system may determine that an advertisement for an advertiser is not suitable for any slot that satisfies these conditions. If this is the case, then this advertiser may not be shown in the auction.

Upon identifying the advertisement value, the data processing system can place the advertiser (or advertisement corresponding to the advertiser) that has the highest value of being shown according to the ranking derived above in the highest position identified for this advertiser. The data processing system may further place the advertiser with the second-highest value of being shown according to the ranking above in the highest position identified for this advertiser that is still available.

The data processing system may continue to repeatedly place the advertiser with the highest value of being shown according to the ranking amongst those advertisers who have not yet been placed in a position in the highest position identified for this advertiser that is still available after higher-ranked advertisers have been placed in a slot. The data processing system may continue this process until either there are no more slots left for the advertisers or the system comes to an advertiser that cannot profitably be shown in any advertising slot.

After determining an estimate of how much value could be generated by the organic links in various configurations and determining an allocation of advertisements to display in the display slots of the interface with the organic search results, the data processing system determines a price to charge the advertisers for their advertisements. In some implementations, the data processing system determines a lowest amount that the advertiser could bid so that this advertiser will still be ranked ahead of the advertiser currently just below the advertiser according to the ranking identified above. The data processing system can then determine the lowest amount that the advertiser could bid so that the highest position in which the advertiser can be shown is at least as high as the position in which the advertiser is shown. The data processing system can then take the maximum of the amounts identified in the two previous steps and charge the advertiser this price per click.

In some implementations, the data processing system can determine the price by determining a first total value of the configuration that was selected when considering both the total value of all the advertisements that were shown (except for the advertiser in question) and the total value of all the non-advertising links that were shown. The data processing system can then determine a second total value of the configuration that would have been selected if this particular advertiser had not participated in the auction when considering both the total value of all the advertisements that were shown (or would have been shown) and the total value of all the non-advertising links that were shown (or would have been shown). The data processing system can charge the advertiser a price per click based on (e.g., equal to or a multiplier of or ratio of) a difference between the first total value and the second total value divided by the advertiser's predicted click-through rate.

Thus, the data processing system of the present solution is configured to consider an amount of value that could be generated by organic non-advertisement links under various configurations of the advertisements and use these estimates of the amount of value generated by the organic links to determine an allocation of advertisements and prices to charge these advertisers. By doing so, the data processing system may select an allocation of advertisements that may maximize or improve or increase or optimize the total value of all links displayed including both the advertising on non-advertising links; set prices for advertisements such that advertisers have an incentive to bid truthfully and advertisers are not charged more than their bid; and improve user experience because advertisements may be less likely to be displayed in cases where they would adversely affect a user's ability to find the relevant organic non-advertising links.

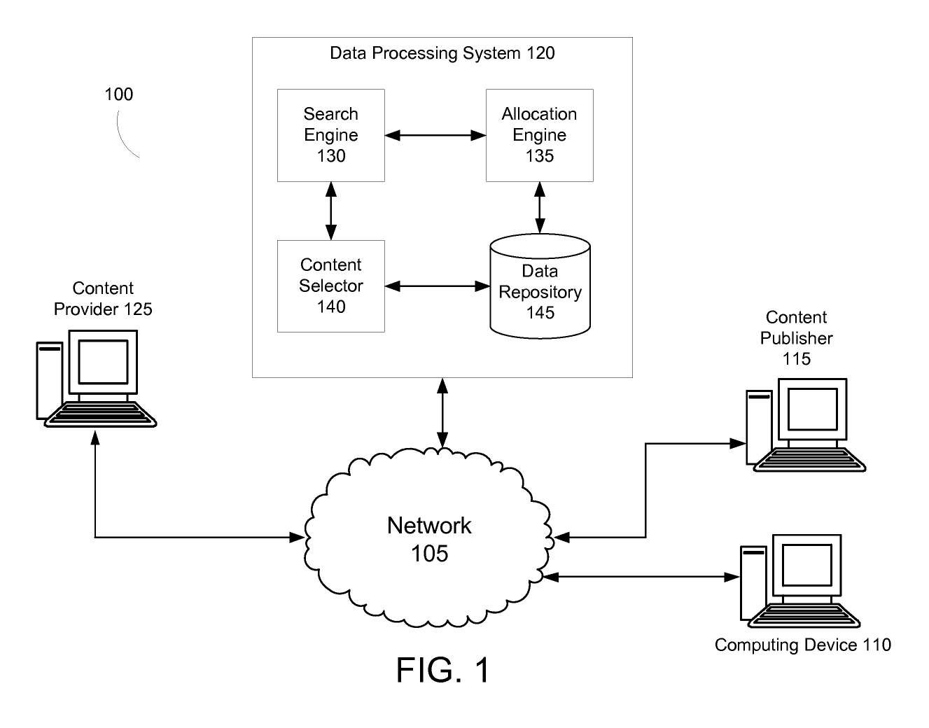

FIG. 1 illustrates an example system 100 for selecting content via a computer network. The content selection infrastructure can include a data processing system 120 communicating with one or more of a content provider 125, content publisher 115 or computing device 110 via a network 105. The network 105 can include computer networks such as the Internet, local, wide, metro, or other area networks, intranets, satellite networks, and other communication networks such as voice or data mobile telephone networks. The network 105 can be used to access information resources such as web pages, web sites, domain names, or uniform resource locators that can be displayed on at least one computing device 110, such as a laptop, desktop, tablet, personal digital assistant, smart phone, or portable computers. For example, via the network 105 a user of the computing device 110 can access web pages provided by at least one web site operator or content publisher 115. In this example, a web browser of the computing device 110 can access a web server of the web site operator or content publisher 115 to retrieve a web page for display on a monitor of the computing device 110. The web site operator or content publisher 115 generally includes an entity that operates the web page. In one implementation, the web site operator or content publisher 115 includes at least one web page server that communicates with the network 105 to make the web page available to the computing device 110.

The data processing system 120 may include or provide access to an online marketplace that facilitates the exchange of items. Items may include, e.g., electronic applications, digital media (e.g., music, television shows, movies, books, magazines, etc.), physical products (e.g., books, goods, widgets, etc.), or other goods or services. The online marketplace may be associated with the data processing system 120 in that an entity that administrates the data processing system 120 may also administrate the online marketplace (e.g., a company owns both the data processing system 120 and the online marketplace). Users via computing devices 110 may purchase items on the online marketplace by exchanging a monetary amount, token amount, points, items, etc. in consideration for an item in the online marketplace. In some cases, the online marketplace may execute on a server separate from the data processing system 120. For example, the online marketplace may execute on a third party server, and the data processing system may request information from the online repository via network (information such as item information), and may also provide content items for display via the online marketplace via the network.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 105 may include a wireless link, such as an infrared channel or satellite band. The topology of the network 105 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The system 100 can include at least one data processing system 120. The data processing system 120 can include at least one logic device such as a computing device having a processor to communicate via the network 105, for example with the computing device 110, the web site operator or content publisher computing device 115, and at least one content provider computing device 125. The data processing system 120 can include at least one server. For example, the data processing system 120 can include a plurality of servers located in at least one data center. The data processing system 120 can include multiple, logically-grouped servers and facilitate distributed computing techniques. The logical group of servers may be referred to as a server farm or a machine farm. The servers can also be geographically dispersed. A machine farm may be administered as a single entity, or the machine farm can include a plurality of machine farms. The servers within each machine farm can be heterogeneous—one or more of the servers or machines can operate according to one or more type of operating system platform.

Servers in the machine farm can be stored in high-density rack systems, along with associated storage systems, and located in an enterprise data center. For example, consolidating the servers in this way may improve system manageability, data security, the physical security of the system, and system performance by locating servers and high performance storage systems on localized high performance networks. Centralizing the servers and storage systems and coupling them with advanced system management tools allows more efficient use of server resources.

The data processing system 120 can include a content placement system having at least one server. The data processing system 120 can also include at least one search engine 130, at least one allocation engine 135, at least one content selector 140, and at least one data repository 145. The search engine 130, allocation engine 135 and content selector 140 can each include at least one processing unit or other logic device such as programmable logic array engine, or module configured to communicate with the database repository or database 145. The search engine 130, allocation engine 135, content selector 140 and data repository 145 can be separate components, a single component, or part of the data processing system 120. The system 100 and its components, such as a data processing system, may include hardware elements, such as one or more processors, logic devices, or circuits.

The data processing system 120 can obtain anonymous computer network activity information associated with a plurality of computing devices 110. A user of a computing device 110 can affirmatively authorize the data processing system 120 to obtain network activity information corresponding to the user's computing device 110. For example, the data processing system 120 can prompt the user of the computing device 110 for consent to obtain one or more types of network activity information, such as geographic location information. The identity of the user of the computing device 110 can remain anonymous and the computing device 110 may be associated with a unique identifier (e.g., a unique identifier for the user or the computing device provided by the data processing system or a user of the computing device). The data processing system can associate each observation with a corresponding unique identifier.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

The data processing system 120 can receive a request for content. The request may include a query such as a search query input into a search engine 130 of the data processing system or online marketplace. The input query may include text, characters, symbols, etc. The data processing system 120 may receive the input query from a computing device 110 via network 105. The input query may include audio (e.g., words spoken by a user of the computing device 110 and input into the search engine of the data processing system via network 105 and an interface). The request may include or be associated with information that facilitates selecting content responsive to the request. The information may include, e.g., contextual information about an electronic document, web page, electronic application, or organic, non-advertisement link on which the selected content is to be displayed. In some implementations, the search engine 130 can be configured to or instructed to perform a categorical search. A categorical search may refer to performing a search of all items (e.g., electronic applications, books, products, services, goods) that fall within a category or correspond to a category (e.g., video games, entertainment, sports, productivity, travel, language, etc.). The search engine 130 may provide an interface displaying input text boxes, buttons, drop downs, or otherwise widgets through which a user of a client can select or otherwise indicate a category for the search.

Responsive to the search query or other request for content (e.g., electronic advertisements), the data processing system 120 (e.g., via content selector 140) can identify, select or otherwise obtain content to be provided or presented via the computing device 110 making the request, or some other computing device 110 associated with the request for content. In some implementations, the data processing system 120 may identify, select, or otherwise obtain content not responsive to receiving any request. The content may include, e.g., text, characters, symbols, images, video, audio, or multimedia content. The request for content can include a request for an online advertisement, article, promotion, coupon, or product description. The data processing system 120 can receive the request from a computing device such as, e.g., computing device 110. For example, the data processing system 120 can receive the request via an application executing on the computing device 110, such as a mobile application executing on a mobile device (e.g., smart phone or tablet). In another example, the data processing system 120 can receive the request via an online marketplace application executing on the computing device 110, such as an application executing on a mobile device (e.g., smart phone or tablet). In some cases, the data processing system 120 may not receive a separate request for content and, instead, select and provide the content (e.g., advertisement) responsive to the search query or with search results. In some instances, a web page may request content from the data processing system 120 responsive to a user of a mobile device 110 visiting the web page (e.g., via a mobile device 110).

The request for content can include information that facilitates content selection. For example, the data processing system 120 may request information from the computing device 110 to facilitate identifying content or content selection. The data processing system 120 may request or obtain information responsive to receiving a request for content from the computing device 110. The information may include information about displaying the content on the computing device 110 (e.g., a content slot size or position) or available resources of computing device 110 to display or otherwise manipulate the content.

The data processing system 120 may identify multiple content items (e.g., a first candidate content item and a second candidate content item) that are responsive to the request for content, or are otherwise candidates for display on an online document (e.g., a web page or a page of an online marketplace). The data processing system may initiate or utilize an online auction process to select one or more of the multiple content items for display on the online document. An auction system may determine two or more bids for content items to be displayed in an online document. The auction system can run the bids through an auction process to determine one or more winning bids. Content items corresponding to the winning bids may be selected for display on or with the online document.

The data processing system 120 may include a content selector 140. The content selector 140 may analyze, parse, or otherwise process subject matter of candidate content items to determine whether the subject matter of the candidate content items correspond to the online marketplace or are otherwise relevant or eligible for display in the available content slots in the interface of the online marketplace. It some implementations, the content selector 140 may select candidate content items based on a matching criteria, relevancy, quality score, or other metric that facilitates selecting a subset of candidate content items from a plurality of candidate content items for display in content slots that a user may be interested in. The content selector 140 may identify, analyze, or recognize terms, characters, text, symbols, or images of the candidate content items using an image processing technique, character recognition technique, or database lookup. The candidate content items may include metadata indicative of the subject matter of the candidate content items, in which case the content selector 140 may process the metadata to determine whether the subject matter of the candidate content item corresponds to the online marketplace. A candidate content item may correspond to the online marketplace if it matches or is relevant to the content to be displayed or rendered (or on display) via the user interface of the online marketplace.

Content providers may provide additional indicators when setting up a content campaign that includes content items. The content provider may provide information at the content campaign or content group level that the content selector 140 may identify by performing a lookup using information about the candidate content item. For example, the candidate content item may include a unique identifier, which may map to a content group, content campaign, or content provider. The content selector 140 may determine, based on information stored in data repository 145 about the content provider (e.g., an electronic application developer), that the candidate content item corresponds to an electronic application, or that the candidate content item is unrelated to the electronic application, but may be otherwise relevant for display on the interface.

The content selector 140 can use the identified information about the candidate content item to determine a similarity metric between the subject matter of the candidate content item and the online marketplace. The similarity metric may indicate a likelihood that subject matter of the candidate content item corresponds to an item being exchanged via the online marketplace. For example, the candidate content item may be an advertisement for a mobile phone game. The online marketplace may include the online mobile phone game. Thus, the similarity score between the candidate content item and the online marketplace would indicate a high level of similarity. The similarity metric may include a numeric score (e.g., scale of 1 to 10 with 10 being the most similar, or vice versa; a grade such as A, B, C; a binary value such as YES or NO, or 0 or 1; a color, a flag, or other indicator that indicates whether the subject matter of the candidate content item corresponds to the online marketplace). This similarity metric can be referred to as, or be used to determine, a quality metric or a predicted click-through rate for the candidate content item.

The content selector 140 can perform a lookup in data repository 145 using the identified subject matter from the candidate content item to determine the similarity metric. The data repository 145 may include a list or index of items provided via the online marketplace. The list may include names of items, titles, authors, producers, serial numbers, SKU numbers, UPC codes, bar codes, or other identifying information about items provided via the online marketplace. The content selector 140 can compare the subject matter of the candidate content item with the item information stored in the data repository to determine a level of similarity. For example, the content selector 140 may determine, based on the similarity metric, that a first candidate content item contains subject matter that corresponds to the online marketplace (e.g., an advertisement for a game that is sold via the online marketplace), and, therefore, the content item corresponds to a higher quality score than another candidate content item that may be less similar. The content selector 140 may perform a broad, exact or phrase match between keywords or other content selection criteria of the content item and the content being displayed via the online marketplace. In some cases, the content selector 140 performs a broad, exact, or phrase match between keyword or other content selection criteria of the content item and a search query input via the online marketplace.

The data processing system 120 may include an allocation engine 135. The allocation engine 135 can be designed and constructed to determine, estimate, or otherwise identify a value of an organic, non-advertisement search result link. The allocation engine 135 can be further designed and constructed to determine, estimate or otherwise identify a value of a candidate content item, such as an electronic advertisement. The allocation engine 135 can translate a display of the organic search result links via a plurality of slots on an interface. For example, first and second organic search results links may be initially slotted for a first and second slot on the interface. However, the allocation engine 135 can translate the display of the search results based on candidate content items and associated characteristics. Further, the allocation engine 135 can reallocate one or more organic search result links based on comparing characteristics or values associated with the organic search result links and candidate content items. For example, the second organic search result link can be relocated from the second slot to a third slot, while an advertisement can be selected for the second slot. Relocation may occur prior to providing the results for display on a client device. Relocation may occur subsequent to identifying search results and candidate content items. Relocation may occur prior to rending the display of the translated interface. In some implementations, relocation may include manipulating the sequence of search results by injecting a candidate content item between search results. In some implementations, relocation may include manipulating the order or placement of candidate content items.

The allocation engine 135 can determine a value of the organic, non-advertisement search result or link based on historical monetization information. The allocation engine 135 can determine the value of the organic link for different configurations of advertisements. For example, the allocation engine 135 may determine that there are four available content slots on the interface of the online marketplace in which to display search results and electronic advertisements. If the data processing system 120 determines to display one electronic advertisement, then the data processing system can display three organic links. If the data processing system 120 determines to display two electronic advertisements, then the data processing system can display two organic links, and so forth. To calculate the value generated by the organic links in each configuration of advertisements, the allocation engine 135 can determine the value generated by the organic link if a user of the online marketplace selects the organic link.

For example, if the search engine 130 identifies search results contained four organic links, the allocation engine 135 can, for each organic link, determine the value that would be generated based on historical monetization information. The historical monetization information may refer to an amount of revenue or funds or benefit received by a proprietor or administrator or entity in charge of the online marketplace or data processing system. The historical monetization information may include or be based on a purchase price of the electronic application or other product or service corresponding to the organic link (or the portion of the purchase price that the administrator of the online marketplace receives). This may include one-time purchase prices, upgrade prices, monthly subscription fees, in-application purchases (e.g., purchasing additional items within the electronic application such as features in an electronic game), revenue received by the online marketplace or administrator of the data processing system from electronic advertisements placed within the electronic application corresponding to the organic link, etc.

The data repository 145 can store historical monetization information for each organic link. The data repository 145 may receive information from the online marketplace regarding purchases, and store this information in a data structure in memory corresponding to the electronic application. The data repository 145 may store a separate data structure for each organic link or electronic application, or include information on all available electronic applications or organic link items in a single data structure in memory or other storage device.

For example, a historical monetization data structure may include a data record or entry or field for an identifier of the electronic application, a corresponding entry or data record for revenue amount, or an entry for each transaction that generated revenue for the online marketplace or administrator of the data processing system. The data repository 145 may maintain such historical monetization records for the entire life of the electronic application; for example, the data record for the electronic application may include entries or historical monetization information from the moment the electronic application launched in the online marketplace up till the current time, or any other time period within the life of the application that facilitates systems and methods of selecting content of the present solution. For example, the data processing system may determine that the first 24 hours, 48 hours or 72 hours following a launch of an electronic application may or may not be representative of an overall average monetization amount due to a spike in revenue. In another example, the data processing system may weight or otherwise account for spikes in revenue due to external factors.

The data repository 145 can store additional information related to the organic link, such as click-through rates, conversion rates, probability of selection, number of impressions, etc. An impression may refer to each instance of the electronic application or link thereto being displayed in the online marketplace as a search result responsive to a search query. A click or selection may refer to a user selecting the organic link. A conversion may refer to a user purchasing the electronic application or downloading the electronic application. A probability of selection may be based on the click-through rate (e.g., number of clicks divided by the number of impressions). The click-through rate may be based on a display slot. For example, the click-through rate for an organic link in a first display slot in a graphical user interface for the online marketplace may be higher than a click-through rate for the organic link when it is displayed on a second display slot that may be different from or lower than the first display slot.

The data processing system 120 can monitor transactions to update the historical monetization data structure to include up-to-date historical monetization information for an electronic application. For example, each time a financial transaction associated with the electronic application occurs, the data processing system 120 may receive an indication of the amount of the financial transaction and store the amount in the historical monetization data structure. The data processing system 120 may include a financial monitor that tracks the historical transactions associated with each electronic application, as the financial transactions may be conducted via a financial engine of the data processing system 120.

The allocation engine 135 can access the historical monetization data structure stored in database 145 to retrieve data records storing historical monetization for an electronic application. In some implementations, the allocation engine 135 may be configured with or designed and constructed to determine a value of the organic link using the historical monetization information. The allocation engine 135 executed by the data processing system can determine a first value generated by displaying the first electronic application (or each electronic application) in a first slot (or each available slot) available on the interface for displaying the search results. The value of the organic link can be based on an historical monetization generated from selection of the first electronic application. For example, the allocation engine 135 can, for each organic link i, denote the amount of value uᵢ that would be generated if a user clicked on or selected that organic link. This amount uᵢ can be based on historical averages of how much revenue was generated on average when a user clicked on the organic link i for an electronic application. The allocation engine 135 may determine, to date, that a first user purchased the electronic application for $1.99, made $15 worth of in-application purchases, and interacted with in-application advertisements that resulted in the online marketplace receiving $0.10 in cost-per-click revenue. Thus, the total revenue for the first user may be $17.09 (or a portion thereof based on the amount of money that is paid to the developer or provider of the electronic application). The data processing system 120 can perform a similar analysis for one or more users that purchased, downloaded or otherwise used the electronic application to determine the total revenue for each user. The data processing system 120 can then determine an average revenue per user (e.g., uᵢ) summing the total revenue for each user and dividing the sum by the number of users that obtained the electronic application. In some implementations, the data processing system 120 may receive or determine the historical monetization information based on a time interval (e.g., weekly, daily, monthly, etc.).

For each organic link i and position in the search results k (e.g., a first display slot, second display slot, third display slot, etc.), q_{i,k} denotes the probability organic link i would be clicked on if the organic link i were displayed in position k of the display slots (e.g., 1^{st}, 2^{nd}, 3^{rd}, or top, middle, bottom, or left, middle, right, etc.). The data processing system 120 can determine, identify or estimate these probabilities based on historical average click-through rates. The click-through rate can refer to a number of clicks divided by a number of impressions of the organic link. The data processing system 120 may record, in an impression log data structure in database 145, each impression of the organic link along with information about the impression, such as the display slot number, time of day, search query that resulted in the organic link being selected for display, etc. The data processing system 120 can retrieve or determine the click-through rate using the information stored in the impression log data structure.

In one example, the data processing system can determine, identify or estimate a position-independent click-through rate for each organic link i, qᵢ, which reflects the historical frequency with which this organic link was clicked when it was displayed in the top slot (e.g., first position), as well as a position normalizer for each position k, nₖ, which reflects the relative rate with which a link is clicked when it is shown in slot k rather than the top slot. The data processing system (e.g., via allocation engine 135) can then determine, identify or estimate q_{i,k} for each position as q_{i,k}=qᵢnₖ.

In some implementations, the allocation engine 135 can further determine the value that would be generated by the organic links under various configurations of the advertisements. The data processing system can retrieve a data record for the first electronic application that indicates a third value based on the historical monetization of the first electronic application and a probability of selection of the first electronic application when displayed in the first slot (e.g., a product of the average revenue per user of the electronic application multiplied by a predicted click-through rate or conversion rate). For example, the allocation engine 135 can sum or combine the total value of the organic link or the organic links in each position where an organic link is shown. For example, X can denote the set of positions on the page that are not occupied by advertisements, and the total value of the organic link or organic links can be given by Σ_{kεX}_{^{u}}_{(k)q}_{_{i,k}}, where u₍ₖ₎ denotes the value of the organic link shown in position k.

Thus, the data processing system can determine a value of the search results including the organic links in various configurations of advertisements, where the configuration may vary the number of organic links and advertisements as well as the position of each.

In some implementations, the content selector 140 can use the value generated by the organic links determined by the allocation engine 135 to select, choose, or determine an allocation for the candidate content items (e.g., electronic advertisements). In some implementations, the allocation engine 135 can determine a second value generated by displaying the first candidate content item in the first slot, where the first value is different from the second value. Based on this comparison, the content selector 140 may select one of the advertisement or organic link for display in the first slot.

In some implementations, the content selector 140 can rank the advertisements by the value of showing the advertisements. The data processing system can retrieve a data record for the candidate content item or advertisement that indicates a value based on at least one of a bid provided by a content provider of the candidate content item, a quality score, a predicted click-through rate, a long-term value, and a revenue resulting from selection of the candidate content item.

For example, vᵢ can denote the value of showing advertiser i. The data processing system (e.g., via allocation engine 135 or content selector 140) can determine this value in a number of ways. For example, vᵢ can include an expected cost-per-1000-impressions bid, where vᵢ=bᵢqᵢ when bᵢ denotes advertiser's i's cost-per-click bid and qᵢ denotes this advertiser's quality score such as a predicted click-through rate. Further, (j) can denote the advertiser with the j^{th}-highest value of being shown and v₍ⱼ₎ can denote the corresponding value of showing this advertiser.

The content selector 140 can select the allocation based on the number of available slots or positions on the interface of the online marketplace. For example, S can denote the set of positions on the page where an advertisement may be shown. For each advertiser i that is ranked among the |S| highest advertisements (where |S| denotes the number of positions in S), the data processing system can determine a highest position s in S that satisfies a criterion. In some implementations, the data processing system can use the following technique to determine the highest position. The content selector 140 can identify the set of all positions on the page that are available (for either advertisements or organic links) (“K”). The total value of the organic links that would be shown if organic links were shown in all positions in the set X can be V (X). The data processing can determine the values of V(K) and V(K\{s}) for each position s ε S, where K\{s} denotes the set of all positions on the page except for position s.

In some implementations, the data processing system can further determine the relative probability xₛ with which advertiser i will be clicked if it is shown in position s. The data processing system can determine, for each advertiser i, the highest position on the page s where both vᵢxₛ+V(K\{s})V(K) and vᵢxₛ+V (K\{s})≧vᵢx_{s′}+V(K\{s′}), where s′ denotes the next highest position in S after s. If the data processing system is unable to identify such a position s ε S for advertiser i, then the data processing system may not show an advertisement of advertiser i as a result of the auction. Thus, sᵢ can denote the highest position in S that satisfies this criterion for advertiser i, with the convention that Sᵢ=Ø if no such position s ε S exists for advertiser i.

The content selector 140 can provide, place, position or otherwise display the highest-ranked advertiser in position s_{( 1)}. The content selector 140 can place the second-highest-ranked advertiser in the highest position that is both no higher than s_{( 2)} and is still available after the highest-ranked advertiser has occupied the position s₍₁₎. Further, for all j≧3, the data processing system can repeatedly place the j^{th}-highest ranked advertiser in the highest position that is both no higher than s(ⱼ) and is still available after the j-1^{th}-highest-ranked advertiser has occupied a position this advertiser has been placed in. The content selector 140 can continue this process until either some advertisement has occupied the last advertising slot in the set S or the remaining advertiser i corresponds to sᵢ=Ø and is not to be shown. At that point, the process can terminate, end or stop, and the allocation of advertisements can be identified, finalized, or provided for display.

Thus, the data processing system 120 (e.g., via the content selector 140 and allocation engine 135) can select, based on a comparison of the value of one or more organic links and the value of one or more advertisements, an electronic application for display in a first slot of the interface and an advertisement for display in a second slot of the interface. The data processing system 120 may further select one of an organic link and an advertisement for each available slot on the interface.

In some implementations, the data processing system 120 can determine a first total value generated based on displaying the first electronic application in the first slot and the first candidate content item in the second slot. The total value may refer to the value or revenue or other benefit provided, received by or otherwise conferred upon the administrator of the data processing system or online marketplace as a result of displaying the organic link in a first slot and the advertisement in a second slot. The data processing system can further determine a second total value generated by displaying the first electronic application in the second slot and the first candidate content item in the first slot. The data processing system can select, based on a comparison of the first total value and the second total value, the first electronic application for display via the first slot of the interface and the first candidate content item for display via a second slot of the interface. For example, the first total value may be greater than the second total value, which may indicate that the optimal selection would be to allocate the organic link in the first slot and the advertisement in the second slot.

Upon selecting the allocation of advertisements and organic links, the data processing system 120 (e.g., via content selector or allocation engine 135) can determine a price to charge the advertiser for placing their advertisement. The data processing system 120 can be configured with one or more techniques for determining the price.

In some implementations, the data processing system 120 can first determine the lowest amount that advertiser i could bid so that this advertiser would still be ranked ahead of the advertiser just below this advertiser. Second, the data processing system can then determine the lowest amount that advertiser i could bid so that vᵢxₛ+V(K\{s})≧V(K) and vᵢxₛ+V(K\{s})≧vᵢx_{s′}+V(K\{s′}), where s denotes the position where advertiser i was shown and s′ denotes the next-highest position in S after s. The data processing system 120 can then determine the maximum of the bids identified in the first and second steps and charge advertiser i a price-per-click equal to this maximum.

In some implementations, the data processing system can use the following technique to determine the price. The data processing system can identify the set of positions A on the page where an advertisement was shown, and then compute a first value of Σ_{jεA}v₍ⱼ₎x₍ⱼ₎+V(K\A)−vᵢxᵢ, where v₍ⱼ₎ denotes the value of the advertiser shown in position j, x₍ⱼ₎ denotes the relative probability with which this advertisement will be clicked if it is displayed in position j, vᵢ denotes the value of advertiser i, and xᵢ denotes the relative probability with which this advertisement will be clicked given the position in which it is shown. The data processing system can then determine the allocation of advertisements that would be selected using this technique if advertiser i had not entered the auction. If Aᵢ denotes the set of positions on the page where an advertisement would be shown in this alternative allocation, then the data processing system can determine a second total value of Σ_{jεA}_{ᵢ}v₍ⱼ₎x₍ⱼ₎+V(K\Aᵢ), where v₍ⱼ₎ denotes the value of the advertiser that would be shown in position j, and x₍ⱼ₎ continues to denote the relative probability with which this advertisement will be clicked if it is displayed in position j. Finally, the data processing system 120 can determine a difference between the second total value and the first total value. The total cost the data processing system charges to advertiser i can be based on or equal to this difference, and the cost-per-click that this advertiser is charged can be based on or equal to this difference divided by the advertiser's predicted click-through rate.

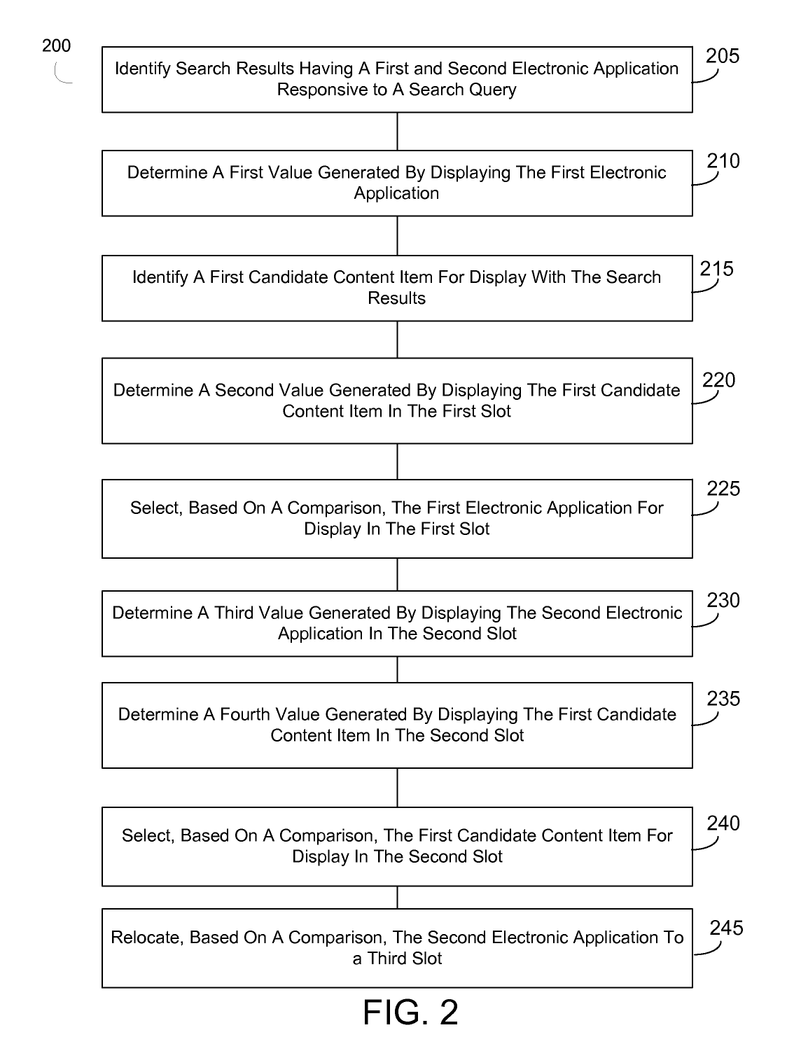

FIG. 2 is an illustration of a method 200 for selecting content via a computer network in accordance with an implementation. The method 200 can dynamically allocate content in an online electronic marketplace graphical interface. The method 200 can be performed by a data processing system or one or more component, engine or module shown in FIGS. 1, 3 and 4. In brief overview, and in some implementations, the method 200 includes a data processing system identifying search results having first and second electronic applications that satisfy or are responsive to a search query at block 205. The data processing system can translate a display of the search via the interface. At block 210, the method 200 includes the data processing system determining a first value generated by displaying the first application in a first display slot. At block 215, the method 200 includes the data processing system identifying a first candidate content item for display with the search results. At block 220, the method 200 includes the data processing system determining a second value generated by displaying the first candidate content item in the first slot. At block 225, the method 200 includes the data processing selecting, based on a comparison of the first value and the second value, the first electronic application for display in the first slot. At block 230, the method 200 includes the data processing system determining a third value generated by displaying the second electronic application in the second slot. At block 235, the method 200 includes the data processing system determining a fourth value generated by displaying the first candidate content item in the second slot. At block 240, the data processing system can select, based on a comparison, the first candidate content item for display in the second slot. At block 245, the method 200 can include the data processing system relocating, based on the comparison, the second electronic application to a third slot.

Still referring to FIG. 2, and in further detail, the method 200 includes a data processing system identifying search results having a first electronic application that satisfies or is responsive to a search query at block 205. The data processing system can identify search results responsive to a search query. The search query may be input into an interface of an online electronic application marketplace. The search engine may receive the search query via a network from a client device, such as a laptop, desktop computer, tablet, or mobile computing device. The search results may identify one or more items that can be provided via the online marketplace to a consumer. The items may include products, goods, or services. In some implementations, the items include electronic applications, such as navigation applications, video games, puzzles, productivity tools (e.g., word processing application, spreadsheet application, presentation application), video applications, etc.

The data processing system can then translate a display of the search results via the plurality of slots of the interface. Translating the display of the search results can include dynamically determining an allocation of content items and organic search results. Translating the display of the search results can include manipulating the display of the search results to include third party content items along with organic links based on a determination. For example, at block 210, the method 200 includes the data processing system (e.g., via an allocation engine) determining a first value generated by displaying the first application in a first display slot. The data processing system can determine the first value generated by displaying the first electronic application in a first slot available on the interface for displaying the search results. The first value can be based on an historical monetization generated from selection of the first electronic application. For example, the data processing system can retrieve or obtain, from a database, an amount of revenue generated by each purchase or download of the electronic application. A selection of the application may refer to a user downloading, installing, or otherwise subscribing to or purchasing an application. For example, a selection may refer to a conversion in that a user has purchased, downloaded, installed, subscribed to or is otherwise using the electronic application. The data processing system can receive in an indication via a user device of the selection, and store an indication of the selection in the database. Along with the indication of the selection from the user, the data processing system can identify an amount of the purchase price of the electronic application and an amount of revenue generated for the online marketplace. For example, the online marketplace may include a database or table storing purchase prices for each electronic application as set by the electronic application providers.

In some implementations, the data processing system can determine a value generated by the electronic application using one more techniques or historical monetization information. For example, the data processing system can retrieve, from memory, a data record for the first electronic application that indicates a value based on historical monetization of the first electronic application and a probability of selection of the first electronic application when displayed in the first slot. For example, selection of the electronic application may have a historical average value on a per user basis. The probability of selection may vary based on which slot the electronic application is displayed in. Thus, the data processing system may determine that a slot-based value of the electronic application for a certain display slot is the value of the application combined with (or multiplied by) the probability of selection in that slot. The data processing system may further determine a total value of the application by combining the probability of selection in each slot with the value of the application (e.g., summing the probability of selection in each slot, and then multiplying the sum by the value that would be generated by selection of the electronic application).

At block 215, the method 200 includes the data processing system (e.g., via a content selector) identifying a first candidate content item for display with the search results. The data processing system may identify a plurality of candidate content items that are candidates for display with the search results on an interface of the online marketplace. The candidate content items may include electronic advertisements. The candidate content items may include content selection criteria, such as keywords, topics, terms, phrases, or entities. A content provider may establish or otherwise provide or select or setup the content selection criteria for the candidate content items. In some implementations, the candidate content items may be associated with one or more content campaign or content group of a content provider.

The data processing system can access a content item repository storing a plurality of electronic content items provided by content providers. The data processing system can select a subset of the content items to be candidate content items using content selection criteria, matching techniques, a relevancy score, quality score, bid amounts, etc. For example, a first content item may be more relevant than a second content item if the first content item includes more keywords that match a search query input into the online marketplace as compared to the second content item. Further, a first content item may have a higher quality score if the first content item has a higher historical click-through rate than the second content item. In some cases, the click-through rate may be specific to keywords of the content item.

At block 220, the method 200 includes the data processing system determining a second value generated by displaying the first candidate content item in the first slot. The first value can be different from the second value. In some cases, the first value may be greater than the second value, and in some cases the first value may be less than the second value. To determine the second value, the data processing system can retrieve a data record for the first candidate content item. The data record can include information about a value of the candidate content item. For example, the information can include historical bid information for the content item, a current bid provided by a content provider of the candidate content item, a quality score, a predicted click-through rate, a long-term value, or a revenue resulting from selection of the candidate content item. The data processing system can determine the second value for the content item based on one or more historical values determined from the data record or advertisement logs.

In some implementations, the data processing system can determine the value of showing the candidate can include an expected cost-per-1000-impressions bid. In some implementations, the value can be based on the advertiser's cost-per-click bid and the advertiser or (advertisement's) quality score (which may refer to or be based on a predicted click-through rate). Thus, a value of a candidate content item may be determined based on the advertiser's bid price and the likelihood of the advertisement being selected or clicked on.

At block 225, the method 200 includes the data processing system selecting, based on a comparison of the first value and the second value, the first electronic application for display in the first slot. For example, the data processing system can select the organic link corresponding to the electronic application for display in the first slot if the estimated value generated by the first electronic application is greater than the estimated value generated by the candidate content item.

In some implementations, the data processing system can determine a first total value generated based on displaying the first electronic application in the first slot and the first candidate content item in the second slot. For example, the data processing system can account for the probability of selection of the electronic application when it is in the first slot and combine this probability with the estimated value generated by the electronic application. The data processing system can sum this combined value with the value of the advertisement when the advertisement is displayed in the second slot (e.g., the advertiser's bid and the predicted click-through rate) to determine a first total value for this configuration. Similarly, the data processing system can determine a second total value for a configuration in which the first electronic application is displayed in the second slot, and the advertisement is displayed in the first slot. The probability of selection of the electronic application may be less when it is displayed in the second slot. The bid or predicted click-through rate of the advertisement may be greater when it is in the first slot. In some implementations, the second total value may be less than the first total value, and the data processing system may select the electronic application for display in the first slot and the advertisement for display in the second slot. In some implementations, the second total value may be greater than the first total value, and the data processing system may select the electronic application for display in the second slot and the advertisement for display in the first slot.

The data processing system 120 can similarly determine an allocation for the second slot. For example, at block 230, the data processing system can determine a third value generated by displaying the second electronic application in the second slot. The data processing system can determine the third value generated by displaying the second electronic application in the second slot based on historical monetization estimates. For example, the data processing system can determine the third value by monitoring transactions (e.g., purchase of the application, in-application purchases, in-application advertisement) occurring from the second electronic application.

At block 235, the data processing system can determine a fourth value generated by displaying the first candidate content item in the second slot. This fourth value can be different from the second value determined if the first candidate content item was displayed in the first slot. This fourth value can be the same as the second value determined if the first candidate content item was displayed in the first slot. The values may be different due to a different probability of selection or a click or conversion associated with the different content slots.

At block 240, the data processing system can select, based on a comparison of the third value and the fourth value, the first candidate content item for display via the second slot of the interface. For example, the fourth value can be greater than the third value, which may indicate a likelihood that greater revenue may be generated from displaying the first candidate content item in the second slot as compared to displaying the second electronic application in the second slot.

At block 245, the method 200 can include the data processing system relocating, based on the comparison of the third value and the fourth value, the second electronic application to a third slot. Thus, the data processing system can translate a display of the search results in slots of the graphical user interface by manipulating the slot allocation of the search results with candidate content items.

In some implementations, the data processing system can identify additional available slots on the interface of the online marketplace. For example, the data processing system can identify a fourth slot available on the interface for display. The data processing system can identify, in the search results, additional electronic applications that satisfy the search query and additional candidate content items or advertisements. For example, the data processing system can identify a third electronic application from the search results and a second candidate content item for display with the search results. The data processing system can determine a fifth value generated by displaying the first electronic application in the first slot, the first candidate content item in the second slot, the second electronic application in the third slot, and the third electronic application in the fourth. The data processing system can further determine a sixth value generated by displaying the first electronic application in the first slot, the first candidate content item in the second slot, the second electronic application in the third slot, and the second candidate content item in the fourth slot. This sixth value may be less than the fifth value. The data processing system can determine not to display the second candidate content item in the first slot, second slot, third slot, and fourth based on the sixth value being less than the fifth value. Thus, the data processing system can provide the third electronic application for display in the fourth slot of the interface.

However, in some cases, this fifth value may be less than the sixth value, and the data processing system can determine not to display the third electronic application in the first slot, second slot, third slot and fourth slot based on the fifth value being less than the sixth value, and provide the second candidate content item for display in the fourth slot of the interface.

In some implementations, the data processing can determine a price for the advertisement. The price for the advertisement may refer to the bid amount that the advertiser that provided the advertisement is to pay as a result of the advertisement being selected for display on the interface of the online marketplace. In some implementations, the price for the advertisement may refer to the bid amount that the advertiser that provided the advertisement is to pay as a result of the advertisement being clicked by a user when the advertisement is displayed on the interface of the online marketplace.

The price the advertiser pays for the impression may be the lowest price that results in the value conferred to the data processing system by the advertisement being greater than a value of the second place advertisement in the action. For example, the price may be the least bid amount that results in the advertiser winning the top available slot. For example, the data processing system can determine a bid price for the first candidate content item based on the bid price of a second advertisement. In some implementations, the data processing system can determine a bid price for the first candidate content item based on the bid price of a second advertisement and a predicted click-through rate or quality score of the second advertisement. In some implementations, the data processing system may further take into account a value generated by the organic link such that the advertisement's bid price allows the advertisement to be displayed in the highest slot on the interface in accordance with the advertiser's maximum bid price. This bid price may place the first candidate content item in the second slot ahead of the second candidate content item, and may also place the first candidate content item in a slot ahead of one or more organic links.

In an illustrative example, the data processing system receives a search query from a user for electronic applications. The search query may be “weather forecast” and may be input into a search engine interface of the online marketplace that includes an input text box. The data processing system may perform a lookup an electronic application repository using the search query to identify several electronic applications whose names, titles, filenames, description, keywords, or other metadata match the search query. For example, the data processing system may identify four candidate electronic applications that match the search query. Links to the electronic application may be referred to organic links because they are responsive to the search query input by the user.

The data processing system determines the average revenue per user of each electronic application based on the purchase price, in-app purchases, or in-app advertisement revenue for the electronic application. The data processing system can determine the average revenue per user of electronic application by tracking the financial transactions that occur between the user's device and the data processing system via the electronic application. Each electronic financial transaction may include an identifier of the electronic application, an identifier of the user, an indication of the amount of the transaction, an indication of the type of transaction or type of revenue. For example, purchasing an accessory in a game application may be an in-app purchase. Data packets may be transmitted from the user device to the data processing indicating the type of purchase, what the purchase is for, the purchase price, the identity of the electronic application (e.g., an alphanumeric identifier), the user's account information, etc.

The data processing system can further use the search query or selected electronic applications to identify candidate content items. The search query may include keywords, terms or phrases. The selected electronic applications may be associated with keywords, terms, descriptions provided by content providers, reviews provided by users, category (e.g., utility application, general, game, sports, entertainment, travel etc.). The data processing system can access a content item repository storing content items provided by content providers to identify a relevant or matching subset of content items to be candidate content items.

The data processing system can determine the number of available display slots in order to determine in which slot to place an electronic application and in which slot to place a content item. The data processing system can further determine a price to charge for the content item.

To make these determinations, the data processing system can access a historical monetization amount (e.g., by monitoring transactions occurring with respect to the electronic application or advertisement) for a first electronic application to determine a value for the electronic application. In some implementations, the data processing system can receive the historical monetization information by tracking financial or other transactions that occur via the electronic application or that are otherwise associated with the electronic application. In some implementations, the data processing system may receive fees from an application developer associated with the electronic application (e.g., fees for placing the electronic application in the online marketplace). Thus, the data processing system monitors or tracks the fees or revenue generated from the electronic application and determines the average revenue generated per user that selected or used the electronic application. This average revenue per user may be the value of the electronic application, or the value of the organic link for the electronic application. In some cases, the value may be probability of selection of the organic link multiplied by the average revenue per user. The probability of selection of the organic link can be based on historical click through rates of the organic link, and may be further based on in which display slot the impression of the organic link occurred.

The data processing system can further determine a value of a first candidate content item by accessing a bid amount of the candidate content item provided or set by a content provider. The value of the content item can be further determined based on a probability of selection of the content item; e.g., the predicted click through rate of the content item (e.g., based on historical click through rate or quality score or relevancy score) times the bid amount. For each display slot, the data processing system can compare the value of the organic link with the value of the candidate content item, and select the one with the greater value.

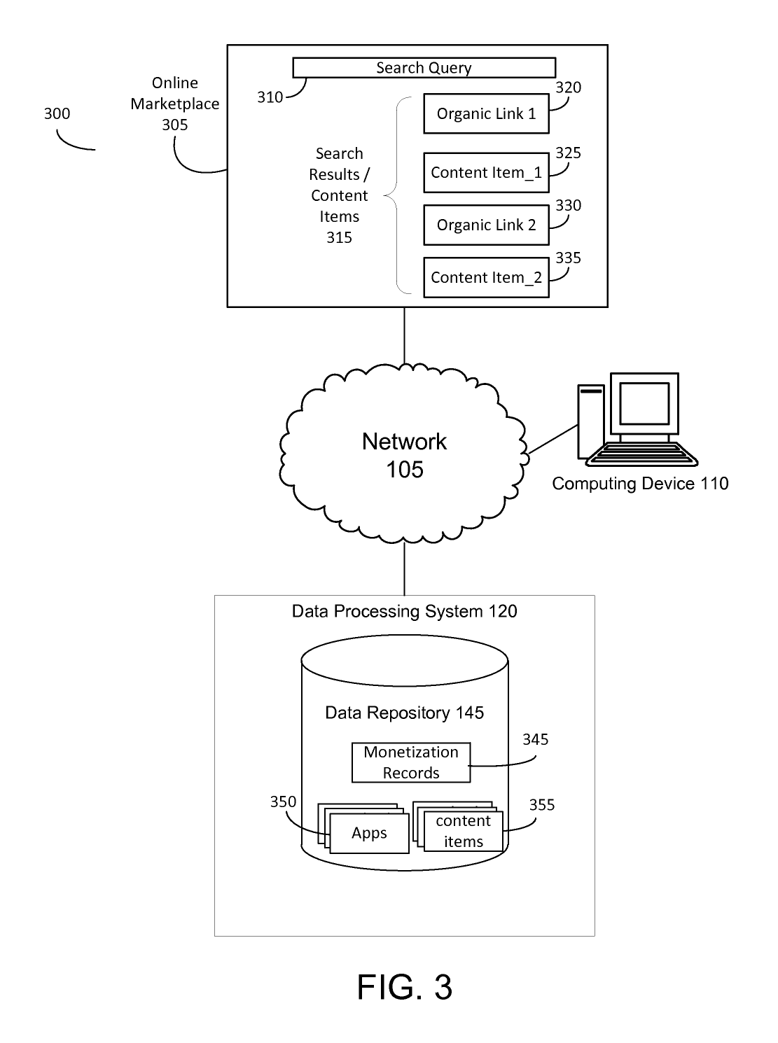

FIG. 3 is a schematic diagram of a system for selecting content via a computer network. The system 300 includes an online marketplace 305, a network 105, and a data processing system 120. The online marketplace 305 can execute or reside on its own data processing system or one or more servers thereof, or on the data processing system 120. The online marketplace 305 can facilitate the exchange of items. For example, the online marketplace 305 can provide, via a graphical user interface, an identification of electronic applications, such as Organic Link 1 320 and Organic Link 2 330. The online marketplace 305 may include a search engine 310 or indexing feature through which a user may enter a search query to facilitate a user identifying items to purchase or otherwise obtain. The online marketplace 305 may include an interface with several available display slots 320, 325, 330 and 335. These display slots may display search results and/or content items 315 such as advertisements. The display slots 320, 325, 330 and 335 may refer to an advertisement slot in some cases, and may include a size (e.g., length and width). The slots may be a placeholder for an organic link, information about a search results, or a content item such as an electronic advertisement.

A computing device 110 may access the online marketplace 305 via network 105. The computing device may enter a search query into a search engine input text box 310. The online marketplace 305 may request search results and/or content items 315 for the display slots. The online marketplace may obtain, from a data processing system 120, organic links responsive to the search query or otherwise satisfy the search query, and content items to be displayed with the organic links. The data processing system 120 may receive, via network 105, such a request for content. The data processing system 120 may identify a first organic link 320 and a second organic link 330 from a pool of organic links for electronic applications. The data processing system 120 may identify a first candidate content item 325 and a second candidate content item 335 from a pool of candidate content items. Each organic link may be associated with a value, and each candidate content item can have a value. For example, the first candidate content item may have been provided by a first content provider that provided a first candidate bid value, and the second candidate content item may have been provided by a second content provider that provided a second candidate bid value. The candidate content items can be stored in data repository 145 in memory.

The data processing system 120 can analyze the values of the organic links and content items to identify an allocation of organic links and content items that may confer a value greater than a threshold for the online marketplace or data processing system. The threshold may be a predetermined threshold or a dynamic threshold. The threshold may be the highest possible value attainable with the search results and candidate content items. The data processing system 120 can include the data repository 145 that may store monetization records 345, electronic applications 350, and content items 355. Monetization records 345 may include historical logs for how much value was generated by an electronic application (e.g., based on purchase price, in-application purchases, advertisements shown within an application, etc.). The monetization record may include a record for each application, and may record transactions associated with the application. For example, a financial transaction associated with an application may include a unique identifier of the application and an amount of the transaction. Further, the online marketplace may receive a percentage or portion of the transaction. The portion of the amount of the transaction received by the online marketplace may be stored in the data record. Further, this record may store each transaction amount or portion thereof, or may store an average amount per user. The average amount per user may be, e.g.: user 1=$10; user 2=$15; user 3=$32; the average is the sum of the amounts ($57) divided by the number of users that selected or are otherwise using the application (3), which is a value of $19 on average per user. Since this value may change, the data processing system 120 may determine an average per user value on a real-time basis, or based on a time interval (e.g., every 24 hours; 12 hours; 48 hours; weekly; monthly, etc.), and update the average per user amount. The data processing system may similarly update a probability of selection of the organic link.

The data processing system 120 may, in some implementations, store the data files for the electronic applications 350, as well as the content items 355 provided by content providers.

The data processing system 120 can provide the selected organic link _1 to the online marketplace 305 for display in the first content slot 320, the content item 1 for display in the second content slot 325, the organic link_2 for display in the third content slot 330, and the content item 2 for display in the fourth content slot 335. The data processing system can provide the links and items via network 105. The online marketplace 305 can display the links and content items item along with an interface, web page, or online document that displays electronic applications or other products, goods or services of an online marketplace. This interface can be provided by the online marketplace 305 via network 105 for display on computing device 110.

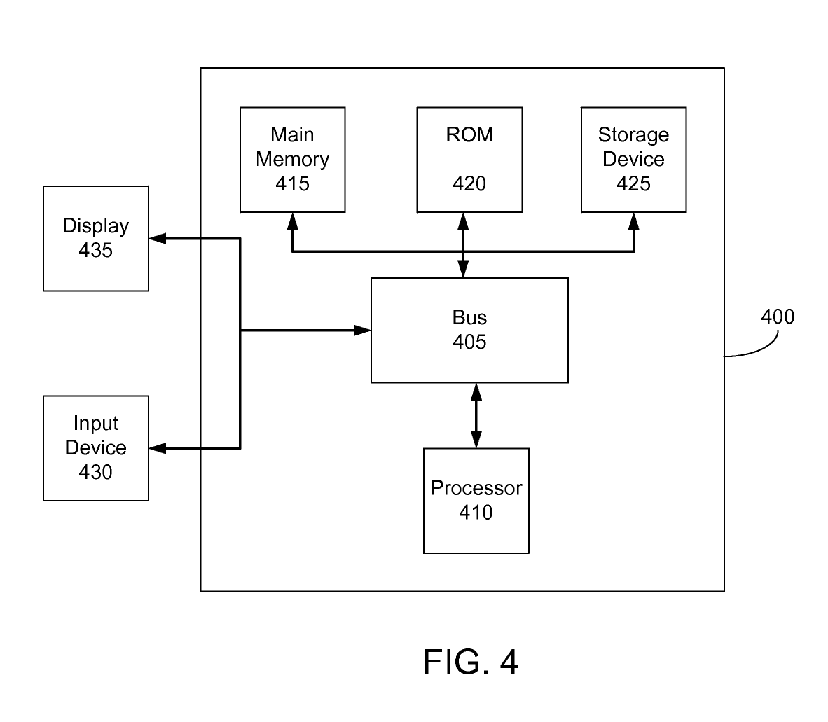

FIG. 4 is a block diagram of a computer system 400 in accordance with an illustrative implementation. The computer system or computing device 400 can be used to implement the system 100, system 300, content provider 125, computing device 110, content publisher 115, data processing system 120, search engine 130, allocation engine 135, content selector 140 and data repository 145. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a read only memory (ROM) 420 or other static storage device coupled to the bus 405 for storing static information and instructions for the processor 410. A storage device 425, such as a solid state device, magnetic disk or optical disk, is coupled to the bus 405 for persistently storing information and instructions.

The computing system 400 may be coupled via the bus 405 to a display 435, such as a liquid crystal display, or active matrix display, for displaying information to a user. An input device 430, such as a keyboard including alphanumeric and other keys, may be coupled to the bus 405 for communicating information and command selections to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. In alternative implementations, hard-wired circuitry may be used in place of or in combination with software instructions to effect illustrative implementations. Thus, implementations are not limited to any specific combination of hardware circuitry and software.

Although an example computing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of dynamically allocating content in an online electronic marketplace graphical interface, comprising:
identifying, by a data processing system comprising one or more processors, search results responsive to a search query input into an interface of an online electronic application marketplace, the search results including an ordered list identifying a first electronic application and a second electronic application that satisfy the search query;
identifying, by the data processing system, a first slot of a plurality of slots available on the interface to display the first search result, and a second slot of the plurality of slots to display the second search result;
translating, by the data processing system, a display of the search results via the plurality of slots of the interface by:
determining, by the data processing system, a first value generated by displaying the first electronic application in the first slot available on the interface, the first value based on monitoring an historical monetization generated from selection of the first electronic application;
identifying, by the data processing system, a first candidate content item for display with the search results;
determining, by the data processing system, a second value generated by displaying the first candidate content item in the first slot, the first value different from the second value;
selecting, by the data processing system based on a comparison of the first value and the second value, the first electronic application for display via the first slot of the interface;
determining, by the data processing system, a third value generated by displaying the second electronic application in the second slot, the third value based on monitoring an historical monetization generated from selection of the second electronic application;
determining, by the data processing system, a fourth value generated by displaying the first candidate content item in the second slot, the third value different from the fourth value;
selecting, by the data processing system based on a comparison of the third value and the fourth value, the first candidate content item for display via the second slot of the interface; and
relocating, by the data processing system based on the comparison of the third value and the fourth value, the second electronic application to a third slot of the plurality of slots available on the interface.

2. The method of claim 1, comprising:
retrieving, by the data processing system from memory, a data record for the first electronic application, the data record indicating a fifth value based on the historical monetization of the first electronic application and a probability of selection of the first electronic application when displayed in the first slot; and
determining, by the data processing system, the first value based on the fifth value and the probability of selection.

3. The method of claim 1, comprising:
retrieving, by the data processing system, a data record for the first candidate content item, the data record indicating a fifth value based on at least one of a bid provided by a content provider of the first candidate content item, a quality score, a predicted click-through rate, a long-term value, and a revenue resulting from selection of the first candidate content item; and
determining, by the data processing system, the second value based on the third value.

4. The method of claim 1, comprising:
determining a first total value generated based on displaying the first electronic application in the first slot and the first candidate content item in the second slot;
determining a second total value generated by displaying the first electronic application in the second slot and the first candidate content item in the first slot; and
selecting, by the data processing system based on a comparison of the first total value and the second total value, the first electronic application for display via the first slot of the interface and the first candidate content item for display via a second slot of the interface.

5. The method of claim 1, comprising:
identifying a fourth slot available on the interface for display;
identifying a third electronic application from the search results;
identifying a second candidate content item for display with the search results;
determining a fifth value generated by displaying the first electronic application in the first slot, the first candidate content item in the second slot, the second electronic application in the third slot, and the third electronic application in the fourth slot;
determining a sixth value generated by displaying the first electronic application in the first slot, the first candidate content item in the second slot, the second electronic application in the third slot, and the second candidate content item in the fourth slot, the sixth value less than the fifth value;
determining not to display the second candidate content item in the first slot, second slot, third slot, and fourth slot based on the sixth value less than the fifth value; and
providing the second electronic application for display in the fourth slot of the interface.

6. The method of claim 1, comprising:
identifying a fourth slot available on the interface for display;
identifying a third electronic application from the search results;
identifying a second candidate content item for display with the search results;
determining a fifth value generated by displaying the first electronic application in the first slot, the first candidate content item in the second slot, the second electronic application in the third slot, and the third electronic application in the fourth slot;
determining a sixth value generated by displaying the first electronic application in the first slot, the first candidate content item in the second slot, the second electronic application in the third slot, and the second candidate content item in the fourth slot, the fifth value less than the sixth value;
determining not to display the second electronic application in the first slot, second slot third slot, and fourth slot based on the fifth value less than the sixth value; and
providing the second candidate content item for display in the fourth slot of the interface.

7. The method of claim 6, comprising:
determining a bid price for the first candidate content item based on the second value and the fifth value, the bid price placing the first candidate content item in the second slot ahead of the second candidate content item.

8. The method of claim 1, comprising:
determining a bid price for the first candidate content item based on the second value, the bid price placing the first candidate content item in the second slot.

9. A system to dynamically allocate content in an online electronic marketplace graphical interface, comprising:
a data processing system comprising one or more processors;
a search engine executed by the data processing system to identify search results responsive to a search query input into an interface of an online electronic application marketplace, the search results including an ordered list identifying a first electronic application and a second electronic application that satisfy the search query;
an allocation engine executed by the data processing system to identify a first slot of a plurality of slots available on the interface to display the first search result, and a second slot of the plurality of slots to display the second search result;
a content selector executed by the data processing system to identify a first candidate content item for display with the search results;
the allocation engine further configured to:
a first value generated by displaying the first electronic application in the first slot available on the interface, the first value based on monitoring an historical monetization generated from selection of the first electronic application;
determine a second value generated by displaying the first candidate content item in the first slot, the first value different from the second value;
select, based on a comparison of the first value and the second value, the first electronic application for display via the first slot of the interface;
determine a third value generated by displaying the second electronic application in the second slot, the third value based on monitoring an historical monetization generated from selection of the second electronic application;
determine a fourth value generated by displaying the first candidate content item in the second slot, the third value different from the fourth value;
select, based on a comparison of the third value and the fourth value, the first candidate content item for display via the second slot of the interface; and
relocate, based on the comparison of the third value and the fourth value, the second electronic application to a third slot of the plurality of slots available on the interface to thereby translate a display of the search results via the plurality of slots of the interface.

10. The system of claim 9, wherein the data processing system is further configured to:
retrieve, from memory, a data record for the first electronic application, the data record indicating a fifth value based on the historical monetization of the first electronic application and a probability of selection of the first electronic application when displayed in the first slot; and
determine the first value based on the fifth value and the probability of selection.

11. The system of claim 9, wherein the data processing system is further configured to:
retrieve a data record for the first candidate content item, the data record indicating a fifth value based on at least one of a bid provided by a content provider of the first candidate content item, a quality score, a predicted click-through rate, a long-term value, and a revenue resulting from selection of the first candidate content item; and
determine the second value based on the third value.

12. The system of claim 9, wherein the data processing system is further configured to:
determine a first total value generated based on displaying the first electronic application in the first slot and the first candidate content item in the second slot;
determine a second total value generated by displaying the first electronic application in the second slot and the first candidate content item in the first slot; and
select, based on a comparison of the first total value and the second total value, the first electronic application for display via the first slot of the interface and the first candidate content item for display via a second slot of the interface.

13. The system of claim 9, wherein the data processing system is further configured to:
identify a fourth slot available on the interface for display;
identify a third electronic application from the search results;
identify a second candidate content item for display with the search results;
determine a fifth value generated by displaying the first electronic application in the first slot, the first candidate content item in the second slot, the second electronic application in the third slot, and the third electronic application in the fourth slot;
determine a sixth value generated by displaying the first electronic application in the first slot, the first candidate content item in the second slot, the second electronic application in the third slot, and the second candidate content item in the fourth slot, the sixth value less than the fifth value;
determine not to display the second candidate content item in the first slot, second slot, third slot, and fourth slot based on the sixth value less than the fifth value; and
provide the second electronic application for display in the fourth slot of the interface.

14. The system of claim 9, wherein the data processing system is further configured to:
identify a fourth slot available on the interface for display;
identify a third electronic application from the search results;
identify a second candidate content item for display with the search results;
determine a fifth value generated by displaying the first electronic application in the first slot, the first candidate content item in the second slot, the second electronic application in the third slot, and the third electronic application in the fourth slot;
determine a sixth value generated by displaying the first electronic application in the first slot, the first candidate content item in the second slot, the second electronic application in the third slot, and the second candidate content item in the fourth slot, the fifth value less than the sixth value;
determine not to display the second electronic application in the first slot, second slot third slot, and fourth slot based on the fifth value less than the sixth value; and
provide the second candidate content item for display in the fourth slot of the interface.

15. The system of claim 14, wherein the data processing system is further configured to:
determine a bid price for the first candidate content item based on the second value and the fifth value, the bid price placing the first candidate content item in the second slot ahead of the second candidate content item.

16. The system of claim 9, wherein the data processing system is further configured to:
determine a bid price for the first candidate content item based on the second value, the bid price placing the first candidate content item in the second slot.

17. A non-transitory computer readable medium having instructions to dynamically allocate content in an online electronic marketplace graphical interface via a computer network, the instructions comprising instructions to:
identify search results responsive to a search query input into an interface of an online electronic application marketplace, the search results including an ordered list identifying a first electronic application and a second electronic application that satisfy the search query;
identify a first slot of a plurality of slots available on the interface to display the first search result, and a second slot of the plurality of slots to display the second search result;
identify a first candidate content item for display with the search results;
determine a first value generated by displaying the first electronic application in the first slot available on the interface, the first value based on monitoring an historical monetization generated from selection of the first electronic application;
determine a second value generated by displaying the first candidate content item in the first slot, the first value different from the second value;
select, based on a comparison of the first value and the second value, the first electronic application for display via the first slot of the interface;
determine a third value generated by displaying the second electronic application in the second slot, the third value based on monitoring an historical monetization generated from selection of the second electronic application;
determine a fourth value generated by displaying the first candidate content item in the second slot, the third value different from the fourth value;
select, based on a comparison of the third value and the fourth value, the first candidate content item for display via the second slot of the interface; and
relocate, based on the comparison of the third value and the fourth value, the second electronic application to a third slot of the plurality of slots available on the interface to thereby translate a display of the search results via the plurality of slots of the interface.

18. The non-transitory computer readable medium of claim 17, wherein the instructions further comprise instructions to:
retrieve, from memory, a data record for the first electronic application, the data record indicating a fifth value based on the historical monetization of the first electronic application and a probability of selection of the first electronic application when displayed in the first slot; and
determine the first value based on the fifth value and the probability of selection.

19. The non-transitory computer readable medium of claim 17, wherein the instructions further comprise instructions to:
retrieve a data record for the first candidate content item, the data record indicating a fifth value based on at least one of a bid provided by a content provider of the first candidate content item, a quality score, a predicted click-through rate, a long-term value, and a revenue resulting from selection of the first candidate content item; and
determine the second value based on the third value.

20. The non-transitory computer readable medium of claim 17, wherein the instructions further comprise instructions to:
determine a first total value generated based on displaying the first electronic application in the first slot and the first candidate content item in the second slot;
determine a second total value generated by displaying the first electronic application in the second slot and the first candidate content item in the first slot; and
select, based on a comparison of the first total value and the second total value, the first electronic application for display via the first slot of the interface and the first candidate content item for display via a second slot of the interface.
